(19) United States
(12) Patent Application Publication
(10) Pub. No.: US 2005/0034075 A1
(43) Pub. Date: Feb. 10, 2005

(54) GIS-based emergency management

(75) Inventors: Edward A. Riegelman, Colorado Springs, CO (US); Daniel C. Huber, Woodland Park, CO (US); Luke A. Heyerdahl, Littleton, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: CH2M HILL, Inc., Englewood, CO (US)

(21) Appl. No.: 10/456,019

(22) Filed: Jun. 5, 2003

(51) Int. Cl. G09G 5/00; H04M 1/00

(52) U.S. Cl. 715/714; 715/739; 715/745; 715/747; 715/810; 715/811; 715/821; 715/825; 455/414.1; 455/414.2; 455/414.3; 455/414.4; 455/456.1; 455/556.2; 715/712; 715/713

(57) ABSTRACT

A GIS-based system and method for simulating, viewing, analyzing and managing emergency or other events is provided. A multi-layered map of the event location and surrounding area is displayed by a computer. A cordon area around the event location may be displayed as an additional layer and affected facilities may be highlighted. Traffic control points (TCPs) around the periphery of the cordon area may also be identified on the map. Thus, emergency personnel may be efficiently dispatched to assist evacuations and restrict access to the cordon area. If the event includes a hazardous material spill or threat, the computer may generate a plume dispersion model and display the estimated plume as another layer on the map whereupon an extended cordon area may be displayed and additional affected facilities and new TCPs highlighted. Real-time information may be received from on-scene personnel, remote sensors and other means and the map may thus be kept current.

### TECHNICAL FIELD

The present invention relates generally to the field of emergency management and in particular, to a GIS-based system and method for simulating, viewing, analyzing and managing emergencies.

### BACKGROUND ART

Heretofore, management of information during emergency events has been difficult due to the diverse information required to be received for various sources, then assimilated, analyzed and acted upon. Additional difficulties occur when attempts are made to disseminate information back out to those in the field or elsewhere. Even with modern technology, it has been difficult to obtain an overall, “high level” picture of an emergency situation. Even the use of computerized maps has limitations, particularly with respect to viewing real-time information. Keeping track of a situation using paper-and-pencil methods may be adequate for relatively small events but will quickly become overwhelming and break down with larger events or with multiple, simultaneous events. Moreover, current computerized methods, as well as paper-and-pencil methods, have been lacking in their ability to allow those with a need to know, such as emergency responders and government officials, to view timely and relevant information.

More specifically, the recent terrorist events in New York City and Washington, D.C. underscore the need not only for increased protection of key facilities and infrastructure, but also for the ability to quickly and accurately evaluate emergency events (whether man-caused or natural) and coordinate appropriate responses. As part of an effort to increase protection, a further need exists to simulate emergency events in advance and evaluate various possible responses.

### SUMMARY OF THE INVENTION

The present invention provides a GIS-based system and method for simulating, viewing, analyzing and managing emergency and other types of events. The system includes a user interface and a computer-executable GIS extension application interfaced with a GIS database. The user interface includes a display window and a user-input device. The GIS extension application is programmed to: receive a user-selected event from the input device; highlight a user-selected event location on the displayed selected map; receive a user-selected cordon input from the input device; in response to the cordon input, display a cordon area around the event location on the displayed selected map; determine which displayed facilities and infrastructure are affected by the selected event; and highlight the affected facilities and infrastructure on the displayed selected map. Affected infrastructure may include road intersections designated by the application as traffic control points (TCPs). The status of individual affected facilities, infrastructure and TCPs may be indicated in the display window. Additionally, the application may be programmed to generate a plume dispersion model and display the estimated plume. Further affected infrastructure may then include TCPs in and around the estimated plume.

Real-time information may be received from on-scene personnel, remote sensors and other means and the map display may thus be kept current. Accurate and up-to-date information may be rapidly disseminated to emergency personnel, the media and government officials.

When the present invention is used to simulate events, analysis of the displayed information may be used to develop and evaluate the effectiveness of emergency preparedness plans and determine what additional measures might be beneficial.

### BRIEF DESCRIPTION OF THE DRAWINGS

FIG. 1A is a block diagram of a computerized GIS-based emergency management system of the present invention;

FIG. 1B is a block diagram of the computer component of the GIS-based emergency management system of the present invention;

FIG. 2A is a diagram illustrating the overlaying of multiple layers of information onto a GIS base map;

FIG. 2B is a computer screen shot of a GIS base map with multiple layers of information overlaid thereon;

FIG. 3 is a computer screen shot of the map of FIG. 2A on which an event has been located;

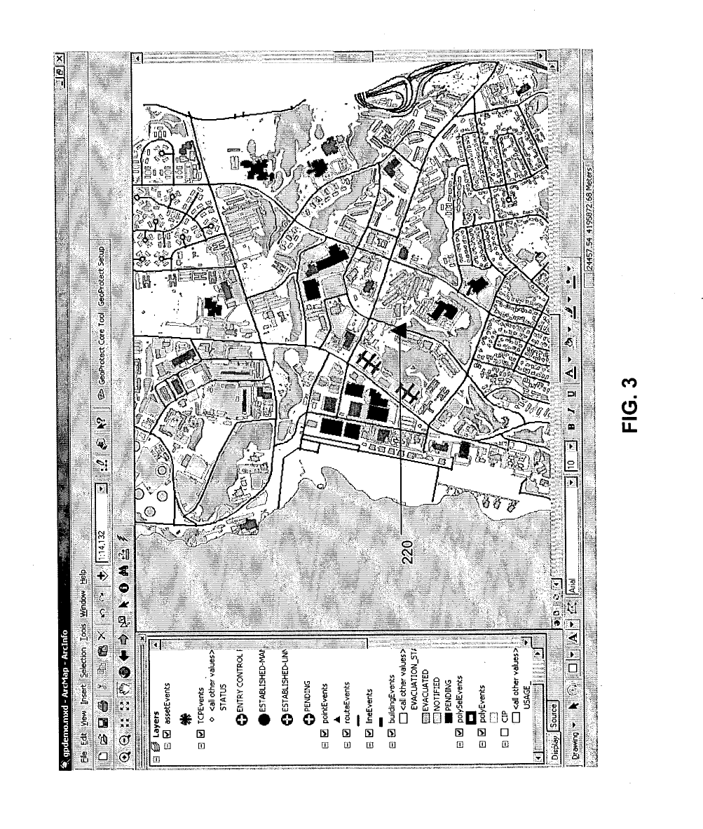

FIG. 4 is a computer screen shot of the map of FIG. 3 on which a cordon has been selected and overlaid around the event location;

FIG. 5 is a computer screen shot of the map of FIG. 4 on which a plume has been overlaid;

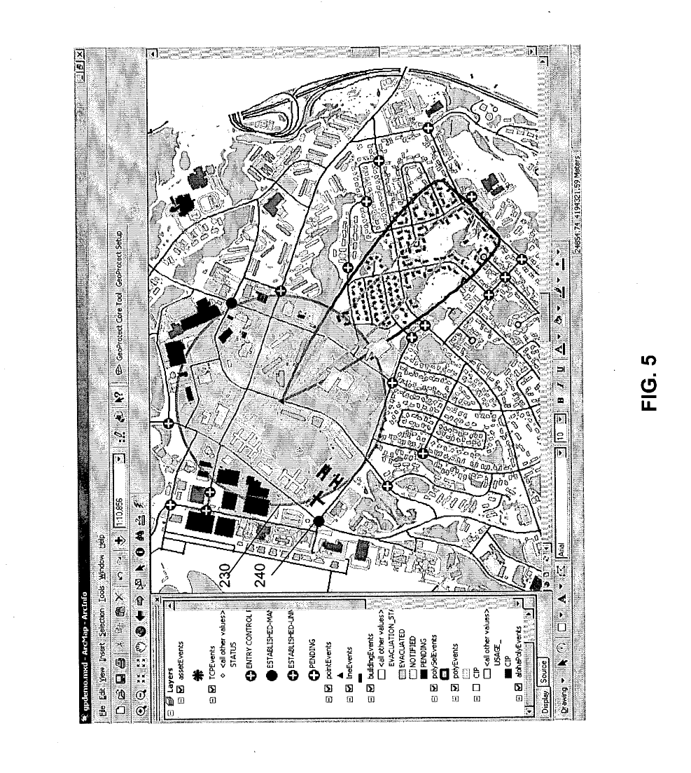

FIG. 6 is a flow chart of the GIS-based emergency management system of the present invention; and

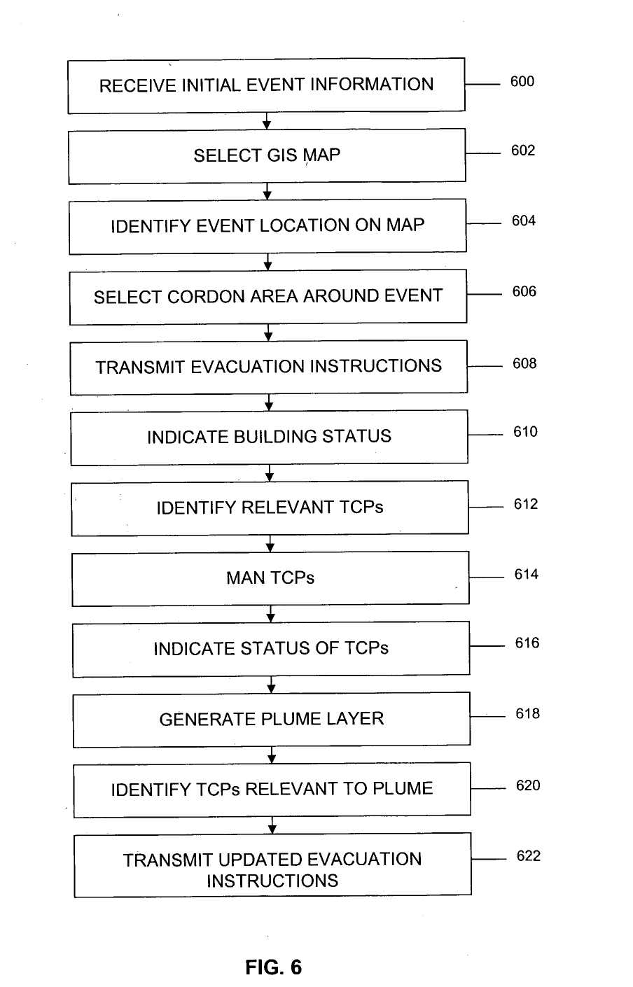

FIG. 7 is an exemplary computer screen shot with multiple windows in which various features of the present invention may be displayed.

### DETAILED DESCRIPTION OF THE PREFERRED EMBODIMENT

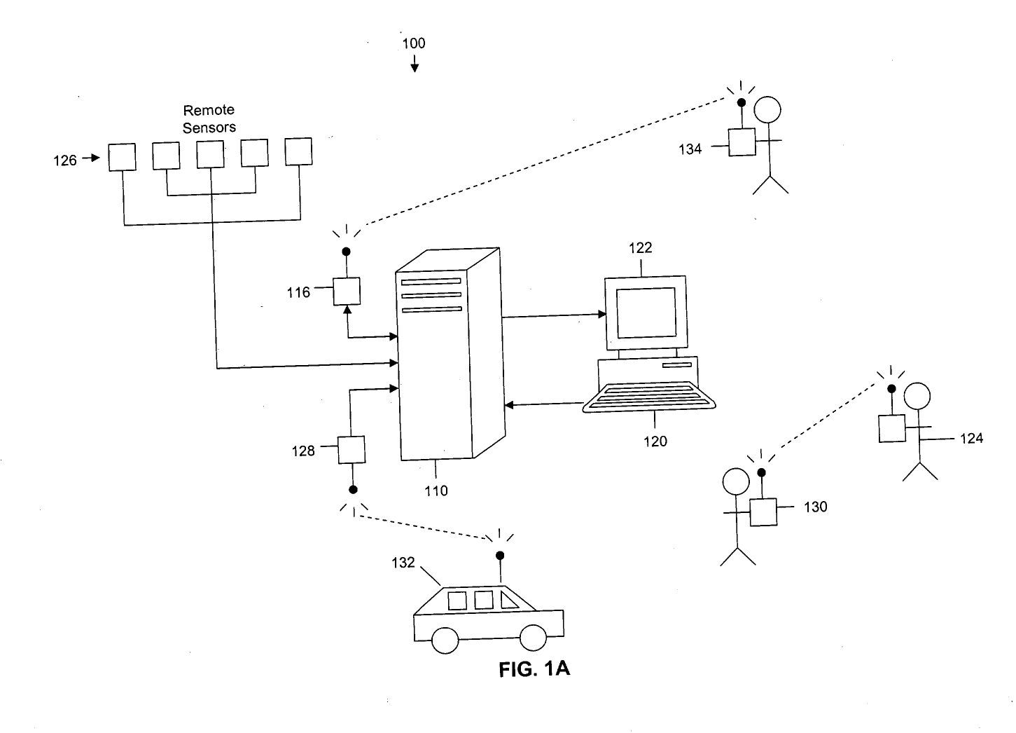

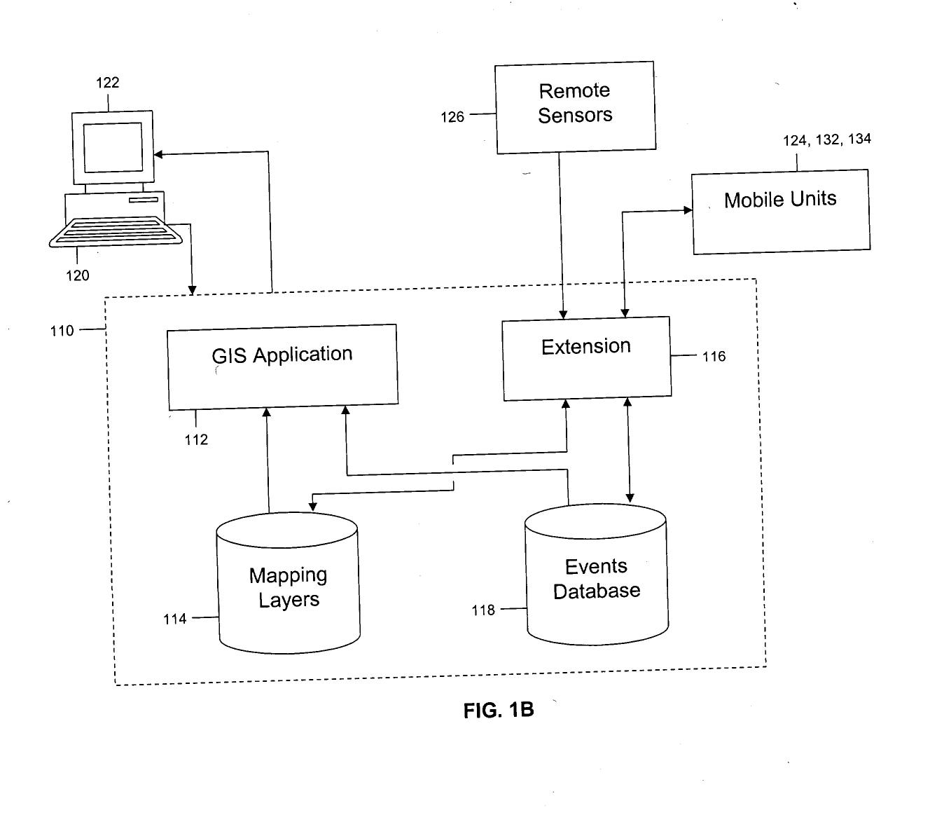

FIG. 1A is a block diagram of a computerized GIS-based emergency management system 100 of the present invention. The system includes a computer system 110 with a user input device, such as a keyboard and mouse 120, and a display device 122. Generally, the computer system 110 will be located in a central command center but may instead be located in a mobile command center or elsewhere. Additionally, the command center may comprise multiple computer systems in one or multiple geographic locations. However, for purposes of clarity herein, the system will be described a single computer system 110 in a single location. Although much information may be received at the command center by telephone or radio from individuals 124 located at or near the scene of an emergency, other means for receiving information are also available. For example, optional real-time remote sensors 126 (such as cameras, toxic chemical sensors and biological sensors) may be coupled to the computer system 110 through wired or wireless networks and optional receivers 128 and 130 may receive information from mobile computers in vehicles 132 and from wireless handheld computers or PDAs 134. Information may also, of course, be disseminated to the individuals 124, mobile computers 132 and PDAs 134 through similar means.

FIG. 1B is a block diagram of the computer component of the GIS-based emergency management system illustrated in FIG. 1A. The computer 110 includes a GIS application 112 with access to a mapping database 114 used to generate selected mapping layers. The computer 110 further includes an extension application 116, interfaced with both the GIS application 112 and the mapping database 114 as well as to an events database 118 which is used to generate and display events-related information on the display 122.

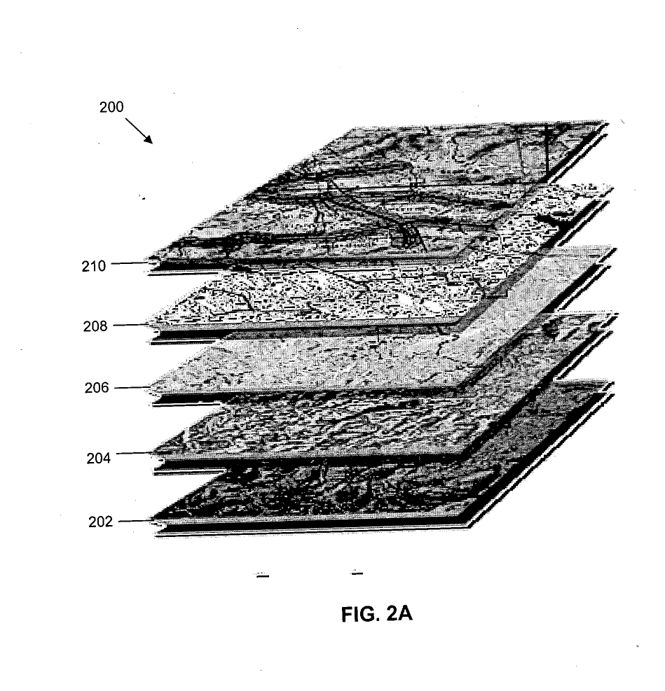

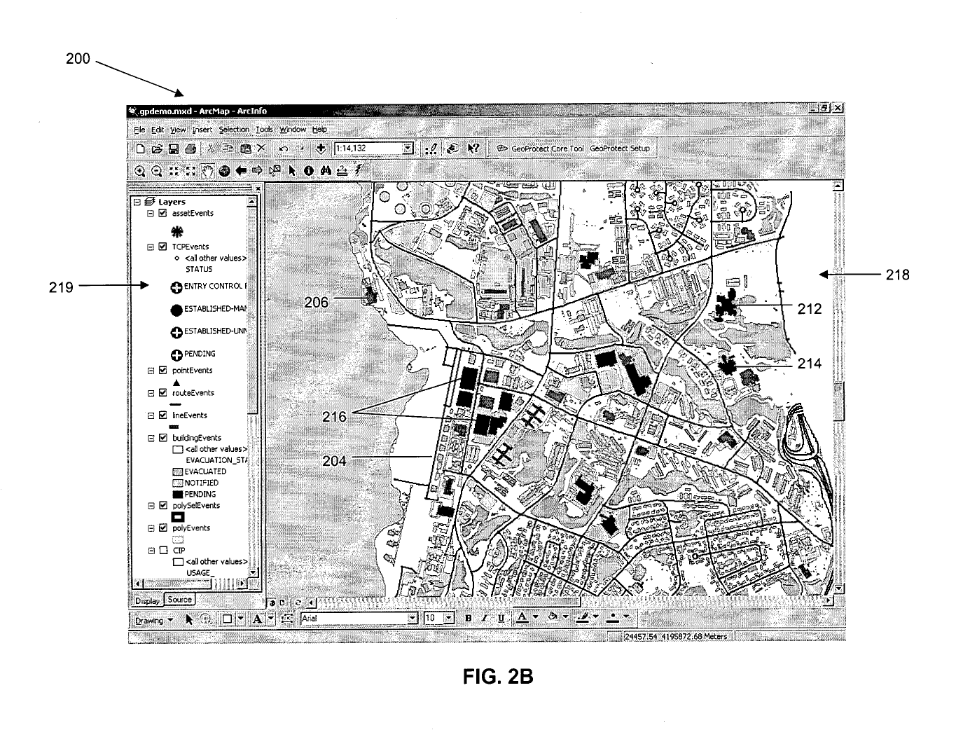

Geographic Information System (“GIS”) based maps have become widely used and may be generated by such software as ArcView by ESRI. FIG. 2A illustrates such a map which includes a base map 202, displaying basic geographic features about a selected area. Additional information may be generated and displayed on layers on top of the base map 202. For example, layers containing streets 204, buildings 206 and other infrastructure 208 and 210 may be displayed, thereby presenting a detailed view of the selected area. The data from which the base map 202 and layers 204-210 are generated may be obtained from numerous sources and the known process will not be described herein. When viewed on the computer display 106, the combined layers 202-208 may resemble the map 200 illustrated in FIG. 2B. The map 200 displays a base area selected from a map database overlaid with a layer to display streets and highways 204 and a layer to display buildings and houses 206. Another layer highlights selected buildings such as hospitals 212, governmental buildings 214 and other infrastructure 216 (such as power plants, water treatment facilities, utilities, police and fire stations, etc.). Although not displayed on the map 200, other facilities such as dams, reservoirs, fuel storage, schools, transportation centers, etc. may also be selected for highlighting. Still another layer displays roads and highways 222. Different highlighting, shading or colors may be used to indicate types of roads. An address, building name or other identifying information may be obtained by moving a pointer over the desired location. Building floor plans and other such details may also be obtained from a computer database. For example, if the facility is a chemical plant, information about the physical layout, employee locations, utility layout, piping layout and chemical inventory may be gathered and stored in the database for later access during an emergency. As illustrated in FIG. 2B, the map 200 may be displayed in one window 218 while events-related menus may be displayed in a second window 219.

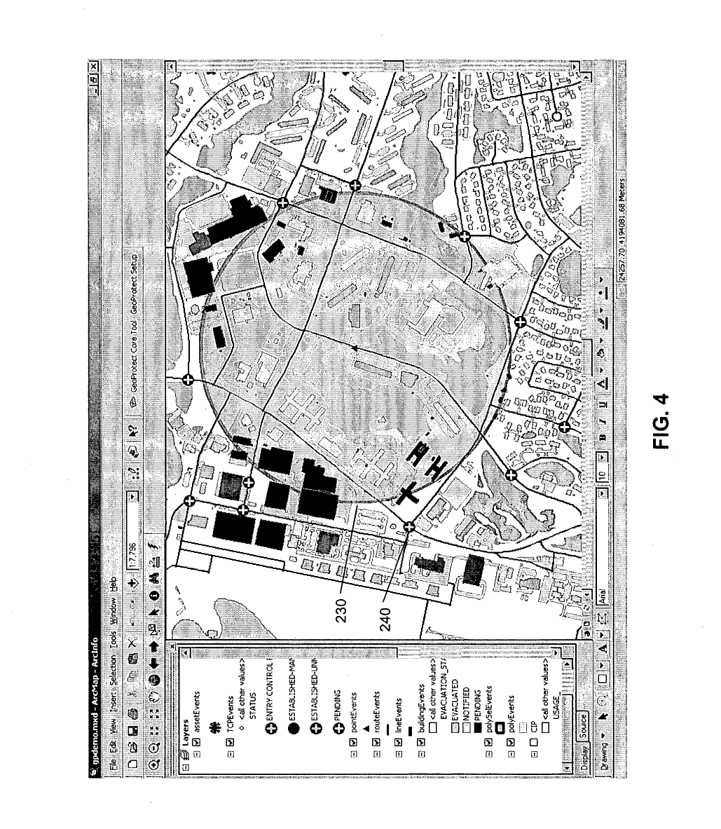

In the event that an emergency occurs (or is to be simulated), information will be received in the command center by any of various means (step 600). For purposes of this disclosure, the event is assumed to be a hazardous material spill. The operator of the computer system 110 will select an appropriate map 200 (step 602) and then mark the center of the event on the map 200 (step 604), such as with the triangle 220. The operator may select the location 220 on the map with a cursor or may enter the address in response to which the computer 110 places the triangle 220 on the map 200 at the correct location. Based on received information and prepared plans, the operator will select a cordon area (or footprint of the affected area) around the center of the event 220 (step 606). The cordon area may be circular, based on an input radius, such as the cordon area 230 highlighted in FIG. 4, or may be some other calculated, selected or drawn shape, depending upon the nature and extent of the event. Based upon the displayed cordon 230, evacuation information may be transmitted to on-scene emergency personnel and to the media (step 608). The status of buildings within the cordon area 230 may be indicated (step 610) by changing their shading, coloring or highlighting to show whether occupants of a building have been notified and, if so, whether they have fully evacuated.

Also based on the cordoned area 230 and underlying GIS data, the computer 110 determines the location of relevant road intersections or traffic control points (TCPs), which affect traffic entering and exiting the cordon area 230 (step 612). The TCPs may then be displayed on the map 200 as an additional layer, such as the TCP 240. Thus, personnel in the command center may direct police, for example, to take up stations at specific TCPs to help guide the flow of people leaving the cordon area 230 and preventing non-essential personnel from entering (step 614). Moreover, as the TCPs become manned, the shading, coloring or highlighting of their respective indicators 240 on the map 200 may be changed (step 616), thereby providing an immediate visual indication of the status of each TCP.

In the current example, the emergency involves hazardous materials. As further information is received at the command center, including the type, state and amount of hazardous material, an additional layer may be generated from a plume dispersion model such as “ALOHA” (step 618), and the resulting projected plume 250 displayed as another layer on the map 200. (ALOHA is a program developed jointly by the National Oceanographic and Atmospheric Agency and the Environmental Protection Agency and generates projected plumes based on an event's geographic location, the chemical type and volume and atmospheric conditions.) In response, the computer 110 may identify and highlight additional buildings within the plume and identify and display additional relevant TCPs 242 around the plume 250 (step 620) whereby further evacuation routes may be determined and access restricted (step 622).

In light of recent actual and threatened terrorist activities, as well as the possibility of natural disasters, the emergency management system of the present invention may be employed as part of broader contingency planning to address various events in advance of their occurrence and develop recommended measures to protect people, facilities, infrastructure and resources. Such planning may include the following steps:

1) Key assets may be identified using technologies such as GIS, GPS (global positioning system) and remote sensing imagery. The assets may include water resources, utilities, storage tanks, transportation centers, major commercial and industrial facilities, medical facilities, significant tourist attractions, choke points, power plants and distribution sites, water treatment and storage facilities, government and military facilities, etc.

2) Once key assets have been identified, relationships between assets may be evaluated to determine what cascade or multiplier effect might result if multiple assets are damaged or destroyed simultaneously.

3) Various “what if” scenarios may then be simulated on the computer system of the present invention.

4) The simulations may be analyzed and recommendations developed to protect the assets, evacuate people, re-route traffic and route emergency vehicles, critical utilities and supplies.

5) Based on the analyses, it may be determined that corrective or mitigating measures for particular assets are warranted. Further simulations may be conducted to forecast the potential effectiveness of such additional measures.

6) Thus, decision makers can easily and rapidly navigate to and view essential, up-to-date information using a map-based interface.

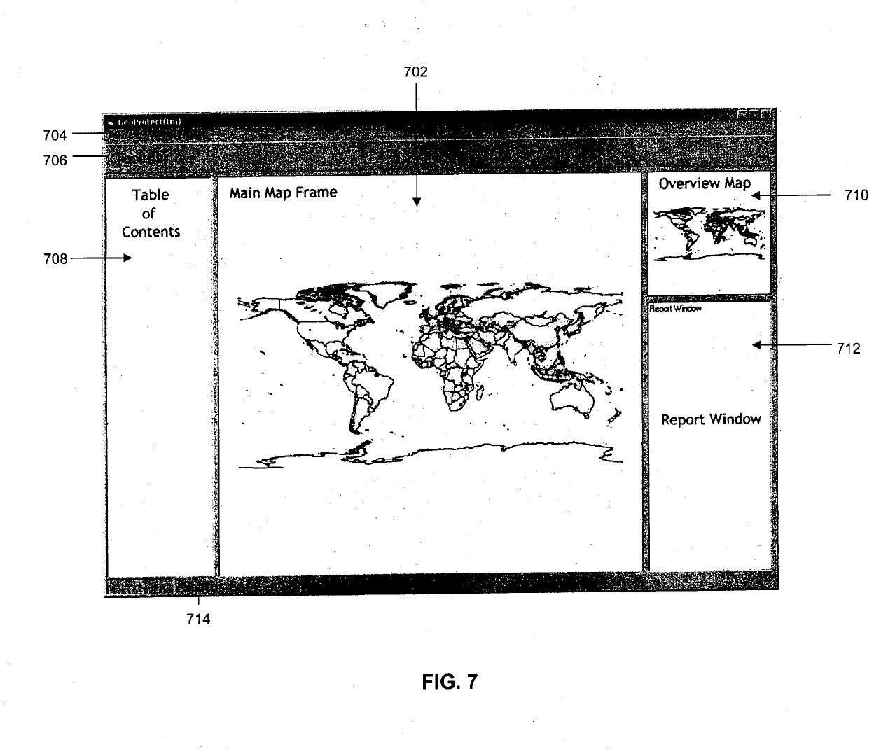

The extension application 116 provides features which supplement those provided by the GIS application 112. Certain core features may be available in all versions of the application while other features may be included to enhance and customize the application for particular clients. These features will be described with reference to the exemplary screen shot of FIG. 7.

### Display Window

The GIS application extension 116 provides a user interface which divides the screen of the display device 122 into several sections. These sections may include:

Main Map Frame: A Main Map Frame 702 displays all geographic data and selected layers in map format.

Menu Bar: A Menu Bar 704 provides an interface for various functional dialogs.

Tool Bar: A Tool Bar 706 provides a location in which to store various functional buttons.

Table of Contents: A Table of Contents 708 displays a list of layers which are available to be displayed on the Main Map Frame 702, selections to control the visibility of the layers and selections to manage hierarchical relationships among layers.

Overview Map: An Overview Map 710 displays an “area of responsibility” (AOR) defined by the user. A bounding box on the Overview Map 710 indicates the extent of the display on the Main Map Frame 702.

Report Window: A Report Window 712 displays the results of queries and events generated by various functions of the application 116. The results may be in tabular form, provide links to further information about an event or may be in other appropriate forms.

Status Bar: A Status Bar 714 displays general information about the status of the application.

### Features

Standard Map Navigation:

Description: “Drill down” capability such as Pan, Zoom-In and Zoom-Out.

Implementation: Buttons in the Tool Bar 706 are available for each of these functions. When the Pan button is selected, the screen cursor is displayed as a “hand” icon over the Main Map Frame 702. When the user presses and holds the left mouse button and drags the cursor, the information on the map is moved the same distance, effectively re-centering the map display but not changing the scale. When the Zoom-In button is selected, the cursor is displayed as a “magnifier” icon with the “+” symbol over the Main Map Frame 112. When the user presses and holds the left mouse button and drags the cursor, a bounding box is displayed representing the new extent of the Main Map Frame 112. When the user presses and releases the left mouse button, the map display is re-centered on the cursor location and the map scale is increased by a predetermined factor. When the Zoom-Out button is selected, the mouse cursor is displayed as a “magnifier” icon with the “−” symbol over the Main Map Frame 112. When the user presses and holds the left mouse button and drags the cursor, a bounding box is displayed representing a factor of the new extent of the Main Map Frame 112. When the user presses and releases the left mouse button, the map display is re-centered on the cursor location and the map scale is decreased by a predetermined factor.

Special Zoom Functions:

Description: Special Zoom functions allow the user to zoom to various options.

Implementation: One means used to implement the Special Zoom function is a button in the Tool Bar 706 which brings up a dialog form to allow the user to input search requirements for the feature or item to which the user wishes to zoom. For example, to obtain information about a particular building, text input boxes are available for each of the following options: building number, building name and building address. After the user fills in one of the boxes and press a “Query” button, the search begins of the geographic database 114. If the item is found, the map in the Main Map Frame 702 will be re-centered on the selected item and the map scale will be adjusted to show the entire item (preferably highlighted) and some of the surrounding area. If the desired building is not found, a message box will be displayed to so inform the user.

An alternative means to implement the Special Zoom function is to provide a combination box to display all the current events that are on the map. In this context, “events” are dynamic geographic objects which represent incidents having some importance to the user. When the user selects a particular event from the combination box, the map display is re-centered on the event and the scale is adjusted so that the entire event is visible along with some of the surrounding area.

Still another means to implement the Special Zoom function is to provide a text input box for each of the following possible coordinate inputs: decimal degree, UTM, MGRS and state plane. After entering coordinates in one of the boxes, the user selects a “Zoom to” button to cause the map display to be re-centered on the coordinate; again the scale adjusts to show the area of interest.

And, another means to implement the Special Zoom function is to provide a text input box to allow the user to input the name of a street, address or intersection. After filling in the box and selecting the “Zoom to” button, the requested information will be queried from the appropriate database. If the desired item is found, the map will be re-centered on the item, the item will be highlighted and the appropriate scale will be applied. If the item is not found, a message box will be displayed to so inform the user.

It will be appreciated that other means to implement the Special Zoom feature may be also implemented.

View Management:

Description: View Management provides hierarchical layer management capability in the Table of Contents to control the visibility of layers on the Main Map Frame 702.

Implementation: Nested groups are used to organize of features which are part of predetermined functional entities. Each group may contain sub-layers or even sub-groups.

Overview Window:

Description: An Overview Window displays an overall user-defined Area of Responsibility (AOR) together with a box which shows the extent of the Main Map Frame 702.

Implementation: A separate map view frame may be used which include the map features which represent the AOR. The Overview Window provides a layer management interface so the user can control which layers are displayed and the overall extent of the AOR. A bounding box is linked to the Main Map Frame 702 extent and is refreshed whenever the Main Map Frame 702 is refreshed. Additionally, the user may redraw the bounding box to move the extent of the Main Map Frame 702, similar to the Zoom-In/Out tools of the Main Map Frame 702.

Buffer Generation:

Description: Polygons are generated to represent a hazardous area, such as a cordon area, or a region of interest based on user input or external sources.

Implementation: A button on the Tool Bar 706 calls a user interface dialog window which allows for the following inputs:

Buffer Selected Feature: Similar to the Special Zoom feature, the user may either select a feature or query a feature from the database.

The user then provides the name for the buffer and the distance around the feature to be buffered.

Buffer Around Coordinate: Input boxes are available to collect information defining the center and size of a buffer. A coordinate input tool, similar to that used in the Special Zoom feature, may be used.

User Defined Buffer: A User Defined Buffer provides the ability for the user to draw a custom buffer by drawing the appropriate shape on the map itself. An input box collects the name of the buffer.

Buffer Modification: Once a buffer is generated, it may be modified by the user or by an external source such as a modeled hazard plume.

Traffic Control Points:

Description: Location points at street intersections and within parking lots outside of an event polygon are generated to enable emergency managers to be aware of where personnel and traffic barricades are required.

Implementation: A button on the Tool Bar 706 or in the Buffer Generation dialog brings up a user dialog that controls the flow of the following logic:
select the desired event polygon;
based on the event polygon, find all road centerlines and parking lot polygons that intersect the event polygon;
beginning at the edge of the event polygon, trace the road centerlines to the next available intersect outside of the polygon;
place an entry control point at all intersections found;
highlight all parking lots that intersect the event polygon so that managers are aware of the possible travel routes; and
generate a report that describes each traffic barricade; the report may be edited so that the status of each barricade can be tracked and managed.
   Buffer Feature Selection:

Feature: Features of interest contained within an event polygon may be selected by the user and an appropriate report generated.

Implementation: A button on the cordon generation dialog brings up a dialog form that allows the user select and highlight features and generate a report. The report is editable to allow for updating the status of selected features.

Hazard Plume Generation:

Description: The user may input various parameters pertaining to a vapor hazard and relevant meteorological data. A downwind hazard plume is generated and displayed on the map.

Implementation: A button on the Tool Bar or on the buffer generation dialog is provided that calls a dialog window for interfacing with a plume dispersion model, such as the aforementioned ALOHA modeling application. If a real-time feed from nearby weather station is available, the meteorological data may be based on that feed. The user fills in the quantity and type of hazardous material and a predicted hazard plume is generated from the ALOHA application and displayed on the map. If an evacuation buffer was previously generated, it may be modified to include the predicted downwind hazard. If entry control points were also previously generated, they may be updated to include the new evacuation area. Additionally, the model may be re-run and the map updated at predetermined intervals based on new weather and other information.

Road Network Routing:

Description: Road Network Routing provides traffic management capabilities in and around an incident and allows the closest required assets (fire, police, ambulance, maintenance vehicle, bulldozer, etc.) to be selected based on estimated travel times.

Implementation: A button on the Tool Bar 706 or on the buffer generation dialog calls up a Network Routing dialog which allows the user to:
select the event buffer of interest;
select the routes that need to be redirected; and
select the event location and locate the nearest assets.
   Real-Time Tracking/Collaboration:

Description: Real-time information from sources or other users may be displayed on the Main Map Frame 702. Thus, information created by a local user may be shared by other users.

Implementation: A Menu Bar 704 option is provided to display a configuration dialog that allows for the following options:
start a local “DataTurbine” and create a new Source connection to the DataTurbine;
create a new Source connection on another computer running a DataTurbine; and
search for other sources of information and create a Sink connection to desired data providers.
   Reverse 911 Integration:

Description: Reverse 911 Integration provides an automated system to notify customers or building residents of hazardous events.

Implementation: The event buffer selection tool is integrated with an automated dialing system. The system will call phone numbers and play a prerecorded message to all facilities selected by an event buffer.

Water Distribution Modeling:

Description: Water Distribution Modeling provides an ability to determine the extent of a contamination event to a water system.

Utility Network Tracing:

Description: Utility Network Tracing provides the ability to find systems affected by a break or disruption of a utility (gas, power, communications)

Implementation: A network tracing capability is implemented in which the user may select a point of disruption. The system then shows all facilities which rely on the utility affected by the disruption.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

1. A GIS-based system for analyzing actual and simulated events, comprising:
a computer;
a display device coupled to the computer;
a window displayed on the display device for displaying a selected GIS-based map and selected facilities and infrastructure;
an events menu displayed on the display device for displaying user-selectable events;
a first selecting device coupled to the computer for selecting an event from the events menu;
a second selecting device coupled to the computer for identifying an event location on the displayed map;
an input device coupled to the computer for inputting a cordon area around the selected event location;
a first map layer for displaying the cordon area on the selected map; and
a second map layer for highlighting on the selected map facilities and infrastructure affected by the selected event.

2. The system of claim 1, wherein affected infrastructure includes road intersections designated by the computer as traffic control points traffic for regulation in and around the cordon area.

3. The system of claim 1, further comprising information inputs regarding a status of individual affected facilities and infrastructure.

4. The system of claim 3, further comprising a third selecting device coupled to the computer and responsive to the information inputs for selecting a status indicator for individual affected facilities and infrastructure.

5. The system of claim 3, wherein the information inputs comprise sensors coupled to the computer for providing real-time information.

6. The system of claim 5, further comprising a third map layer for displaying the real-time information on the selected map.

7. The system of claim 1, further comprising:
a plume dispersion model executable on the computer; and
a fourth map layer for displaying an estimated plume resulting from the selected event on the selected map.

8. The system of claim 7, wherein affected infrastructure includes road intersections designated by the computer as traffic control points for traffic regulation in and around the estimated plume.

9. The system of claim 1, further comprising a network interface coupled between the computer and a network, whereby an image of the first window is displayable on a remote display device.

10. A GIS-based system for analyzing actual and simulated events, comprising:
a user interface comprising:
a display window for displaying a selected GIS-based map and selected facilities and infrastructure; and
an user input device; and
a computer-executable GIS extension application interfaced with a GIS database, the application programmed to:
receive a user-selected event from the input device;
highlight a user-selected event location on the displayed selected map;
receive a user-selected cordon input from the input device;
in response to the cordon input, display a cordon area around the event location on the displayed selected map;
determine which displayed facilities and infrastructure are affected by the selected event; and
highlight the affected facilities and infrastructure on the displayed selected map.

11. The system of claim 10, wherein affected infrastructure includes road intersections designated by the application as traffic control points for traffic regulation in and around the cordon area.

12. The system of claim 10, the application further programmed to receive information inputs regarding a status of individual affected facilities and infrastructure.

13. The system of claim 12, the application further programmed to display a status indicator for individual affected facilities and infrastructure in response to the information inputs.

14. The system of claim 10, the application further programmed to:
generate a plume dispersion model; and
display on the selected map an estimated plume resulting from the plume dispersion model.

15. The system of claim 14, wherein affected infrastructure includes road intersections designated by the computer as traffic control points for traffic regulation in and around the estimated plume.

16. The system of claim 10, further comprising an interface for transmitting information to a remote display device on which an image of the display window is displayable.

17. A GIS-based method for analyzing actual and simulated events, comprising:
displaying a selected GIS-based map;
identifying on the map a location of a user-selected event;
displaying on the map a user-defined cordon area around the event location;
highlighting in the displayed cordoned area a first set of affected facilities and infrastructure;
highlighting in an area surrounding the displayed cordoned area a second set of affected facilities and infrastructure; and
in response to received information, changing a status of a highlighted facility or infrastructure.

18. The method of claim 17, wherein the first and second sets of affected infrastructure include road intersections designated by the application as traffic control points for traffic regulation in and around the cordon area.

19. The method of claim 17, further comprising receiving information inputs regarding a status of individual affected facilities and infrastructure.

20. The method of claim 19, further comprising displaying a status indicator for individual affected facilities and infrastructure in response to the information inputs.

21. The method of claim 17, further comprising:
generating a plume dispersion model; and
displaying on the selected map an estimated plume resulting from the plume dispersion model.

22. The method of claim 21, further comprising highlighting in an area surrounding the displayed estimated plume a third set of affected facilities and infrastructure, including road intersections designated as traffic control points for traffic regulation.

23. The method of claim 17, further comprising transmitting information to a remote display device on which an image of the display window is displayable.
